(19) United States
(12) Patent Application Publication
(10) Pub. No.: US 2005/0217490 A1
(43) Pub. Date: Oct. 6, 2005

(54) Device for making coffee-cream for espresso coffee-machines

(76) Inventor: Bruno Bardazzi, San Piero Asieve (IT)

Correspondence Address: HEDMAN & COSTIGAN P.C., 1185 AVENUE OF THE AMERICAS, NEW YORK, NY, 10036, US

(21) Appl. No.: 10/501,018

(22) PCT Filed: Jan. 14, 2002
(86) PCT No.: PCT/IT03/00013

§ 371 Date: Apr. 18, 2005

(51) Int. Cl. A47J 31/00

(52) U.S. Cl. 99/279

(57) ABSTRACT

A device for application to moka espresso coffee machines, for producing coffee-cream comprises, downstream of a filter (5) overlaying a coffee powder holding basket (2), a membrane (7) made of rubber or other elastomeric material including one or more holes (8) having a very small diameter and/or one or more incisions, thereby causing a pressure increase in water passing through the coffee powder, in addition to an increase of the speed of the coffee infusion passing through the holes of the membrane.

### BACKGROUND OF THE INVENTION

The present invention relates to a device to be applied for espresso coffee machines, of the home type, which are conventionally called “moka” machines, for producing the “coffee-cream”.

As is known, to make the so-called “coffee-cream”, i.e. a foamed relatively dense coffee infusion, by using coffee machines for home use is a rather difficult operation.

In fact, for making such a coffee type, it is necessary to supply the infusion water through the powder coffee held in a powder coffee holder basket, with such a pressure and speed as to allow the aromatic parts of the coffee powder to be easily extracted.

For achieving the above mentioned result in moka machines, devices have been already designed, but, said devices, have been found to be very complex and, which is most important, they cannot be applied on existing espresso coffee machines but require the construction of specially designed coffee machines.

### SUMMARY OF THE INVENTION

Accordingly, the main object of the present invention is to provide such a constructively simple and unexpensive device which can be easily applied also to existing moka coffee machines, and which allows to produce, by said machines, the so-called “coffee-cream”.

According to the main feature of the present invention, such device comprises a membrane made of a rubber or other elastomeric material, arranged downstream of the filter overlaying the coffee powder holding recess, said membrane comprising one or more holes of very small diameter, and/or one or more incisions, so as to provide an increase of the pressure eof water passing through the coffee powder, in addition to an increasing of the water speed during said passage, this result being achieved since the heated water must pass through a narrowed passing port.

In particular, said incisions made through said resilient rubber or other elastomeric material membrane can have a rectilinear segment configuration, or they can define a curved pattern, or a mixed pattern, i.e. comprising both rectilinear and curved portions.

Advantageously, said membrane is so constructed as to be rigid with the sealing gasket arranged between the boiler and coffee maker in said machines.

### BRIEF DESCRIPTION OF THE DRAWING

Further objects, characteristics and advantages of the present invention will become more apparent hereinafter from the following detailed disclosure of a preferred embodiment thereof, with reference to the accompanying drawing, where:

FIG. 1 is a longitudinal cross-sectional view of a moka type of espresso coffee making machines, to which a device according to the present invention has been applied.

### DESCRIPTION OF THE PREFERRED EMBODIMENT

The coffee machines shown in the above mentioned figure, is of a conventional type and comprises, in per se known manner, a boiler 1, in which is arranged a fun-like element bearing the coffee powder basket element 2.

On the boiler 1 a top cup element 3 is screwed, said top cup element including a central upright tubular stem 4.

In prior coffee making machines, in the bottom of the coffee maker 3 top cup is arranged a perforated filter 5, and between said filter 5 and boiler 1 a sealing gasket 6 is provided.

According to the present invention, downstream of the perforated filter 5 resilient membrane 7, including one or more microholes 8, having a diameter of few millimeter tens, for example 0.4 millimeters, is arranged.

The above mentioned microholes can also be replaced by small incisions or notches, having a size varying from few tens of millimeters to few millimeters, and which are formed through the mentioned membrane 7.

Said membrane is preferably made of an elastomeric material, having characteristics similar to that of rubber and, for example, can be made by using silicone rubber.

Advantageously, the membrane 7 can be formed so as to form a single piece with the gasket 6.

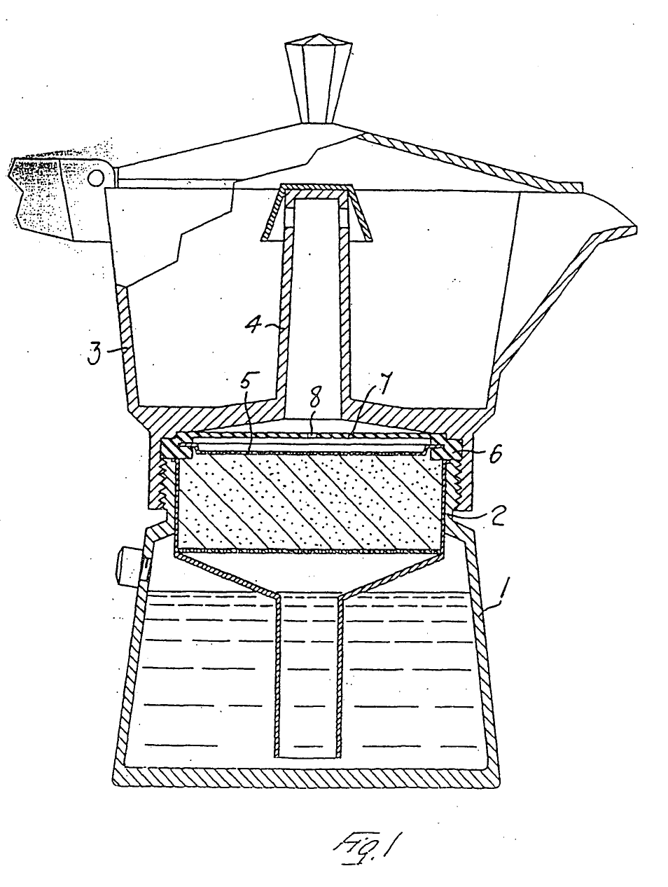

In this case, the gasket 6 comprises a circular notch, formed along the peripheral inner edge thereof, and operating as a housing recess for the peripheral edge of the filter 5, as is clearly shown in FIG. 1.

The above disclosed device should be apparent from the above disclosure.

Actually, in delivering the coffee infusion, as the infusion pressure downstream of the membrane 7 achieves a given value, the central region of the membrane 7 is resiliently deformed, so as to be upward deflected.

The above mentioned deformation causes the mentioned holes 8 to be enlarged, thereby allowing the infusion to quickly pass through the central upright duct 4 into the coffee maker proper 3, while forming the desired “coffee-cream”.

It should be apparent that the invention, as disclosed, is not limited to the shown and disclosed embodiment, but is susceptible to several variations and modifications coming within the scope of the invention and substantially as claimed in the accompanying claims.

1. A device, for application to moka coffee machines, for making the so-called “coffee-cream”, comprising a boiler (1) and a top cup (3), a perforated filter (5) in the bottom of said cup, whereby downstream of said filter (5) overlaying a basket element (2) for holding a coffee powder therein, is applied a membrane (7) made of rubber or other elastomeric material and including one or more microholes (8), and/or one or more incisions, characterized in that said membrane (7) is rigid with a sealing gasket (6) arranged between the coffee machine boiler (1) and cup (3), said sealing gasket (6) including an annular incision extending along its inner peripheral edge for engaging therein an outer peripheral edge of said filter (5).

2. A device, according to claim 1, characterized in that the microholes formed through said rubber or other elastomeric material membrane have a size from 0.1 to 0.7 mm.

3. A device, according to one or more of the preceding claims, characterized in that said membrane is adapted to be deformed by the pressure applied thereon by heated water, which heated water subjects said membrane to a resilient deformation to cause said membrane to assume a bulged configuration, with an upward facing convexity, whereas the water and steam exiting from the coffee machine boiler passes with a high speed through the coffee powder arranged in said coffee powder basket element and said filter.

4. A device, according to one or more of the preceding claims, characterized in that said membrane is subjected to a pressure stress, because of its elasticity, and is so deformed as to cause said microholes and/or slits therefrom to be enlarged thereby allowing a coffee and steam infusion flow to pass with a high speed therethrough.

5. A device, according to one or more of the preceding claims, characterized in that said incisions have either a rectilinear or a curved configuration, or a configuration resulting from a combination of differently shaped portions thereof.

6. A device for application to espresso coffee machines, according to one or more of the preceding claims, characterized in that said membrane (7) is separated from said filter.

7. A device, according to one or more of the preceding claims, characterized in that said membrane (7) operates as a resilient safety valve, designed for allowing a quick passage of the coffee infusion therethrough as in said boiler a pressure corresponding to an optimum temperature for making a coffee-cream is achieved.

8. A device, according to one or more of the preceding claims, characterized in that said resilient membrane, upon ending the coffee infusion flow, automatically assumes its starting arrangement, so as to close said microholes.
